(19) United States
(12) Patent Application Publication
(10) Pub. No.: US 2018/0335062 A1
(43) Pub. Date: Nov. 22, 2018

(54) PANEL CLAMP APPARATUS AND SYSTEM

(71) Applicant: Micah Black, Granite Bay, CA (US)

(72) Inventor: Micah Black, Granite Bay, CA (US)

(21) Appl. No.: 16/048,342

(22) Filed: Jul. 30, 2018

Related U.S. Application Data
(63) Continuation of application No. 14/694,667, filed on Jul. 6, 2015, now abandoned.
Application No. 14/694,667 is a continuation of application No. 13/896,342, filed on May 17, 2013, now abandoned.
(60) Provisional application No. 61/688,643, filed on May 18, 2012.

(51) Int. Cl. F16B 7/04; F16B 5/06; F16B 2/12

(52) U.S. Cl. CPC F16B 7/0486; Y10T 403/42; F16B 2/12; F16B 5/0614

(57) ABSTRACT

A mechanical clamp system for joining two or more panels or other structural elements together at different angles for the purpose of constructing furniture, product displays, art, play equipment, and other desirable structural elements. The clamp system is comprised of a top member and bottom member, the top member and bottom member being held together by a nut and bolt assembly, and the clamp system having transverse mounting elements capable of affixing the clamp system to a wall or other rigid surface with screws or other attachment mechanisms. First and second end portions of each of the top and bottom members are oriented such that the structural elements are rigidly held at a fixed angle with respect to one another.

This application claims the benefit of U.S. application Ser. No. 13/896,342, filed, May 17, 2013, which in turn claims the benefit of U.S. Provisional Application No. 61/688,643, filed May 18, 2012, This invention relates generally to an apparatus and system for joining panel materials. In particular the invention provides an apparatus that aligns and clamps panel materials to form structures, furniture, stands, and enclosures in a manner that is easily removable and reconfigurable.

### BACKGROUND OF THE INVENTION

### Description of Related Art

The mechanical design of clamps for structural building materials is well established. The applicant for the present invention considered several common mechanical clamps with common features and noted the deficiencies below.

Most embodiments of existing clamps are designed to hold materials together in a temporary fashion for drilling, gluing and aligning. Glass clamps hold glass panels in a permanent manner to eliminate holes in the glass panel. In a similar fashion no attempt has been made to provide a method for joining wood, plastic, metal and composite panels without the need for drilling, gluing, or other operations that alter or permanently affix such panels. None of the following prior art inventions have brought the unique features, function, and structural elements of the current invention together: U.S. Pat. No. 5,975,790-clamp for formwork panels, U.S. Pat. No. 4,821,382 fastening element for the connection of two sheet members, U.S. Pat. No. 6,769,750 mechanical joint including angle bracket, U.S. Pat. No. 7,168,693 adjustable angle clamp and US20060065793 brackets for building cushion forts. The resulting inventions do not simplify construction of structures (especially those that are to be load bearing), allow the clamps to be left in place, provide a structural joint element, eliminate permanent affixing operations or alterations, adapt to a range of panel thickness and have the ability to be attached and removed with a single tightening element. There is therefore a need for providing a novel bracket clamp apparatus that provides all of the prior features in one device.

### SUMMARY OF THE INVENTION

The current invention comprises a mechanical panel clamp bracket capable of simultaneously aligning and fixing a panel in place without the need to drill holes, affix screws in, or otherwise alter the panel. These clamp brackets make it much faster to build and disassemble a variety of structures, even using the same panel elements for many applications. The brackets have great novelty and utility in applications such as product/trade displays, where it is advantageous to enable rapid assembly and disassembly of the display. Materials used with the clamps can be readily reused and recycled due to the lack of nails, screws, other common fasteners, or bonding or affixing agents that have been embedded in or applied to a panel material. Another useful application for the current invention is common furniture items. Desks, standing desks, tables, shelves, dog houses, kids play houses, carts, stools, coffee tables, chairs, benches, and the like can all be readily built, and if need be quickly disassembled using the inventive concepts of the current invention. The inventive brackets described herein enhance the use of the above furniture items by allowing the user to customize the dimensions and design to their desired taste.

A better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the various aspects of the present invention, as well as the preferred mode of use, reference should be made to the following detailed description read in conjunction with the accompanying drawings. In the following drawings, like reference numerals designate like or similar parts throughout the drawings:

FIG. 1 is a cross sectional view of the primary embodiment of the present invention. The cross sectional view is created from the plane and direction indicated in FIG. 6.

FIG. 2 is an isometric view of the outside structure of the primary embodiment of the present invention.

FIG. 3 is an isometric view of the inside structure of the primary embodiment of the present invention.

FIG. 4 is a cross sectional view of the primary embodiment showing the present inventions ability to accommodate different panel thicknesses. The cross sectional view in FIG. 4 is created with the same plane and direction as shown in FIG. 6.

FIG. 5 is a cross sectional view of the primary embodiment showing the ability of the present invention to accommodate different panel thicknesses. The cross sectional view in FIG. 5 is created with the same plane and direction as shown in FIG. 6.

FIG. 6 is an isometric view of the primary embodiment of the present invention installed between two panels.

FIG. 7 shows an alternate embodiment of the present invention where the angle between the panel materials is different than 90 degrees.

FIG. 8 shows the use of the auxiliary hole of the present invention for wall mounting functions.

FIG. 9 shows a sectional view of the auxiliary hole of the present invention for wall mounting functions.

FIG. 10 shows an insert accessory for the primary embodiment of the present invention.

FIG. 11 shows an assembly view of a linking plate accessory for the primary embodiment of the present invention.

FIG. 12 shows an isometric view of a linking plate accessory for the primary embodiment of the present invention.

FIG. 13 shows an assembly view of a linking plate accessory with panel materials in accordance with the primary embodiment of the present invention.

FIG. 14 shows a side sectional view of an alternate embodiment of the present invention manufactured using sheet metal fabrication techniques. The sectional view in FIG. 14 is created from plane and direction indicated in FIG. 16.

FIG. 15 shows a bottom view of an alternate embodiment of the present invention manufactured using sheet metal fabrication techniques.

FIG. 16 shows an isometric view of an alternate embodiment of the present invention.

FIG. 17 shows an isometric view of a wall-mounted shelf utilizing multiple units of the primary embodiment of the current invention.

FIG. 18 shows an isometric view of part of a wall-mounted shelf utilizing multiple units of the primary embodiment of the current invention.

FIG. 19 is a table built with wood panels and multiple units of the primary embodiment of the current invention.

FIG. 20 is a corner portion of a table built with wood panels and multiple units of the primary embodiment of the current invention.

FIG. 21 is a coffee table built with wood panels and multiple units of the primary embodiment of the current invention.

FIG. 22 is an isometric view of children's play equipment built with wood panels and multiple units of the primary embodiment of the current invention.

FIG. 23 is another isometric view of children's play equipment built with wood panels and multiple units of the primary embodiment of the current invention.

### DETAILED DESCRIPTION

The present description is of the best presently contemplated mode of carrying out the invention. This description is made for the purpose of illustrating the general principles of the invention and should not be taken in a limiting sense.

All publications referenced herein are fully incorporated by reference as if fully set forth herein.

The present invention can find utility in a variety of implementations without departing from the scope and spirit of the invention, as will be apparent from an understanding of the principles that underlie the invention. For instance, the present invention is best described as used in conjunction with items of furniture, structural art installations, and trade show and retail booth and product displays, however it may find utility when used with a plethora of building materials and systems which including two or more panel or similar elements which are to be joined or assembled together.

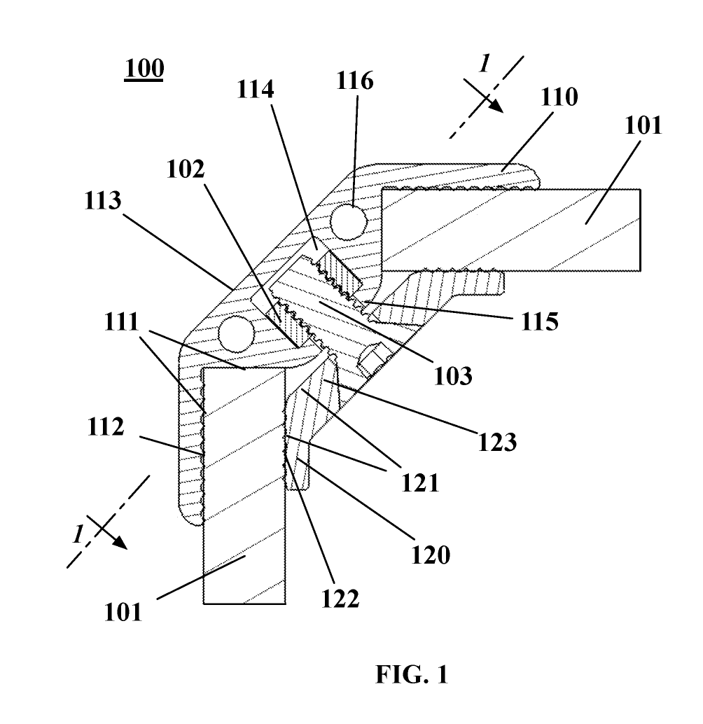

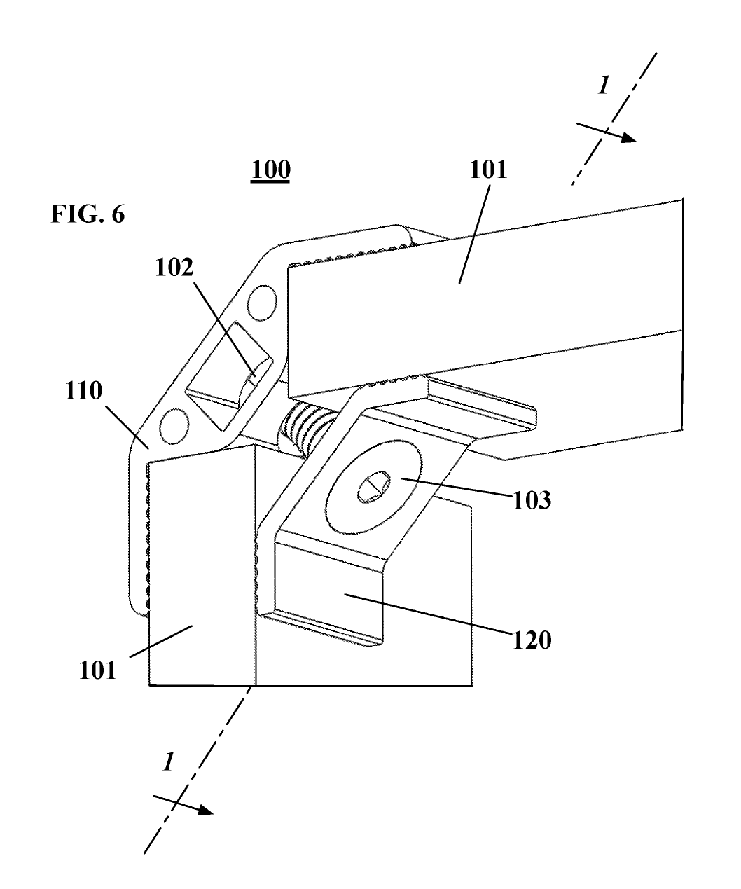

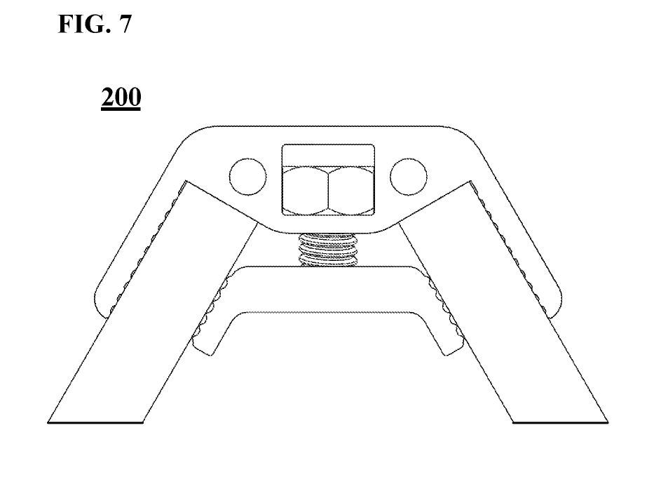

Looking now to FIGS. 1, 2 and 3, various views of the exemplary panel clamp bracket assembly apparatus 100 are shown schematically to illustrate aspects of the current invention. Generally the panel clamp bracket assembly 100 is comprised of two separate parts, outside structure 110, and inside structure 120 connected by nut 102 and screw 103 to from a 90-degree angle between two panels of material. It shall be understood that the illustrated embodiment holds panels at 90 degrees but does not limit the spirit and scope of the invention to right angle connections. FIG. 7 shows a side view alternate embodiment 200 where the panel clamp bracket assembly has a 60-degree angle between the two panels. It will be understood by those skilled in the art that a variety of other angles can be created by altering the design and fabrication process of the current invention without departing from the inventive concepts herein. In addition, the operative clamp portion of panel bracket assembly 100 can be fabricated to be any length or width such that they clasp more or less surface area along the large top and bottom sides of panels 101. FIG. 6 illustrates an exemplary 1-inch thick version of assembly 100 for connecting two panel 101 elements. It will be understood by those skilled in the art that assembly 100 can be fabricated in various sizes, thicknesses, lengths, and widths to accommodate the dimensions of various panel elements to be joined. Elongated versions of the present embodiment and or alternate embodiments would use additional hardware and hole/slot features to place screws at differing lengths along an elongated component. An elongated embodiment would have the advantage of completely enclosing the edge between two panels and also creating a stronger structural joint. It shall be understood that these extended length embodiments could be curved to accommodate non-linear lengths of panels.

Looking now to FIGS. 1, 2 and 3 the outside structure 110 generally includes angled panel surfaces 111 to capture and support panel materials on either side of hardware channel 114 and hole feature 115. Nut 102 is held within channel element 114 of outside structure 110. Screw 103 extends through hole feature 123 of inside structure 120 and hole feature 115 of outside structure 110 to engage nut 102. It will be understood that a variety of materials can be used to create the present embodiment 100 elements. Outside structure 110, inside structure 120, nut 102 and screw 103 can be made from a plurality or combination of metal, plastic, composite, and organic materials to achieve the level of mechanical strength and aesthetic look required by a specific application. Similarly, it shall be understood that alternate embodiments of assembly 100 could eliminate one or both nut 102 and screw 103 by integrating such features into structural elements 110 and 120.

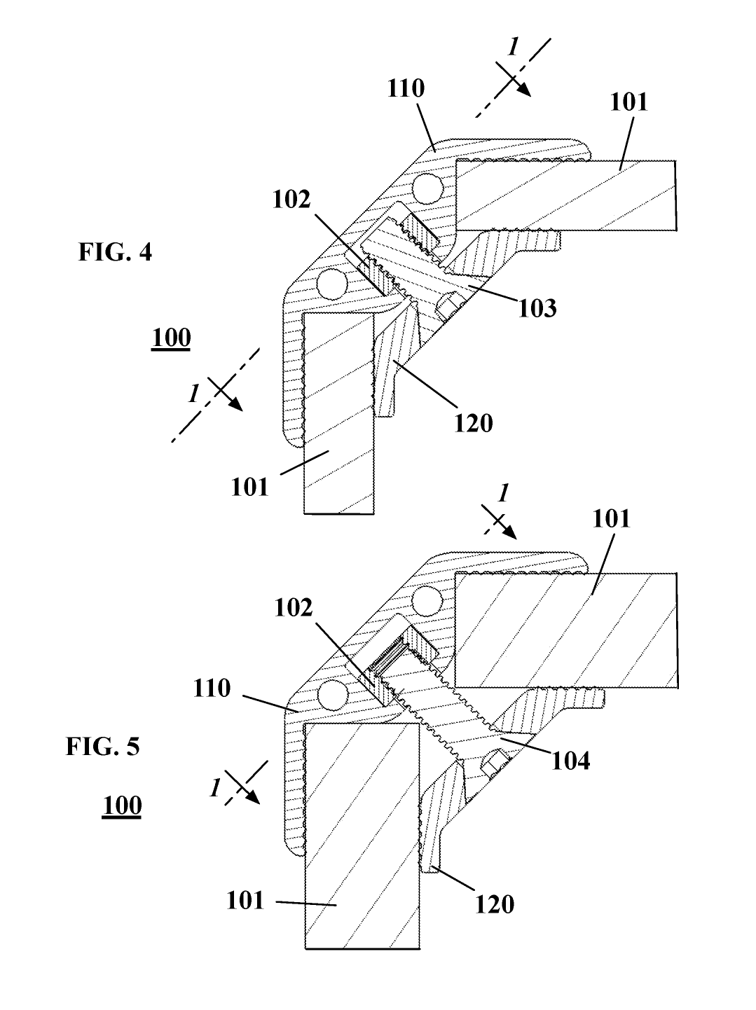

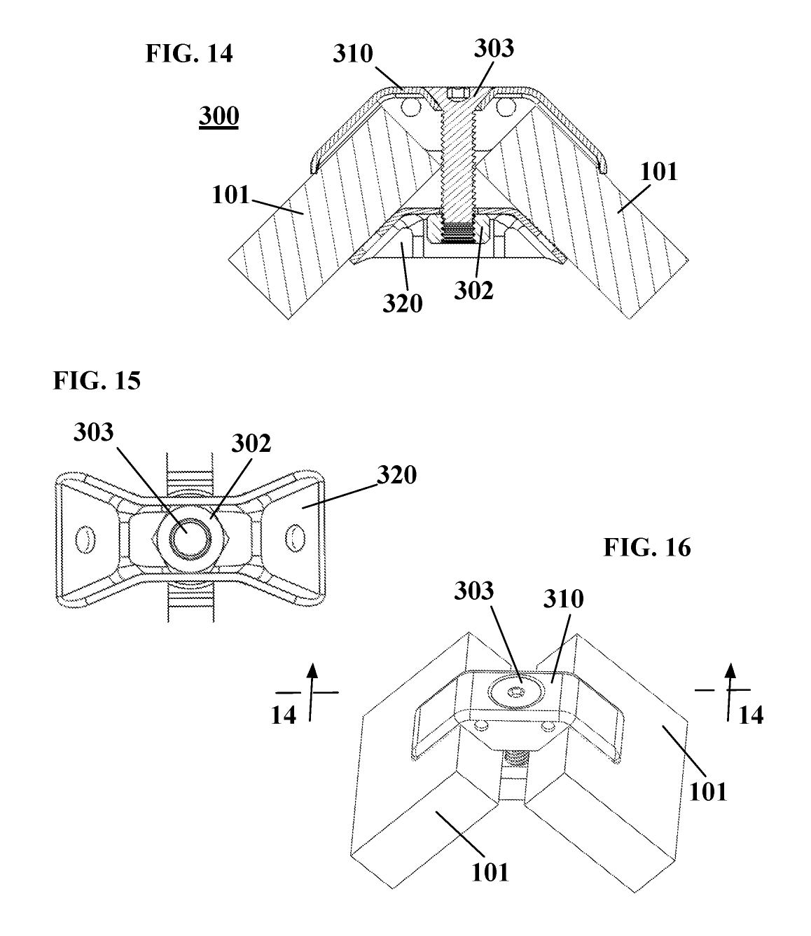

When screw 103 is tightened via the nut 102, inside structure 120 is drawn toward outside structure 110 and engages panel surfaces 111 on outside structure 110 and panel surfaces 121 of inside structure 120 to panel materials 101. The present embodiment of the panel clamp apparatus can use multiple lengths of screws (illustrated as 103 and 104) to accommodate a range of panel 101 thicknesses as shown in FIGS. 4-5. The present embodiment hides screw threads from view within the outside structure 110. The primary embodiment 100 along with alternate embodiments can be scaled to accommodate any panel thickness. FIGS. 14-16 represent alternate embodiment 300 illustrates that a single screw 303 can accommodate a larger range of panel thicknesses without departing from the spirit or scope of the present invention.

Optional grip texture feature 112 and 122 help engage the panel material 101 by proving a rough or ridged surface that increases the friction and material grip function between inside structure 120 and outside structure 110 and panel material 101, the goal of which is to create a robust mechanical between two panels. It will be appreciated and understood that the geometry of grip texture can be designed for a variety of panel materials such as wood, plastic, glass, rubber, and composite materials, or for certain applications, no grip texture may be used.

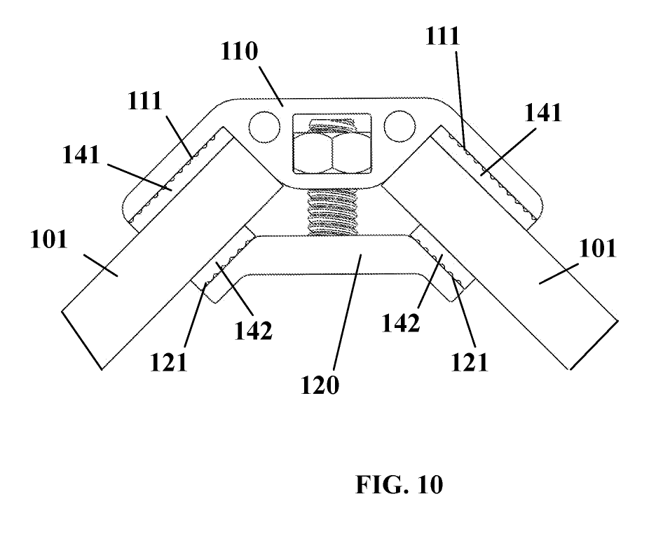

Looking now to FIG. 10 additional insert elements 141 and 142 can be added to panel surfaces 111 and 121 to better accommodate panel 101 materials. It will be understood that a variety of shapes, textures, and adhesives can be employed to wrap or adhere insert elements 141 and 142 to panel surfaces 111 and 121 in order to better grip, and provide cushion for panels 101. In addition, insert elements 141 and 142 can be made from a variety of materials to best grip panel materials 101, such as for example, a rubber component added or adhered to structure 110 and or 120 in the case of glass panel material. It will be additionally appreciated that a combination of grip texture, insert elements, or smooth surface elements could be implemented on panel surfaces 111 and 121 in order to accommodate a particular construction application or design.

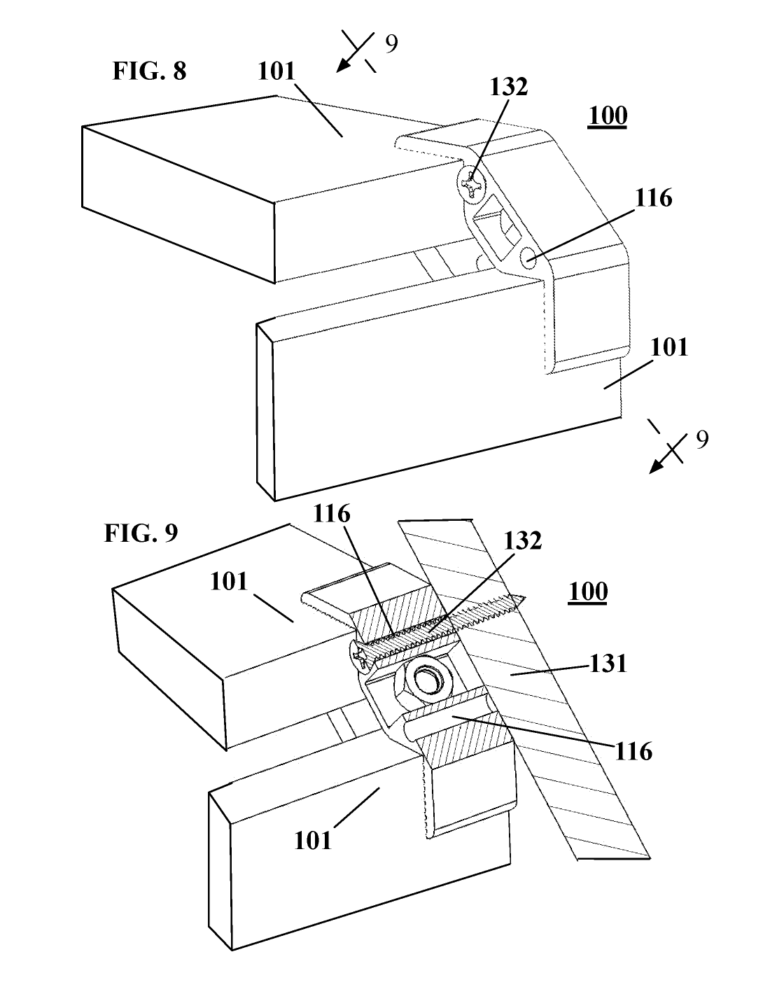

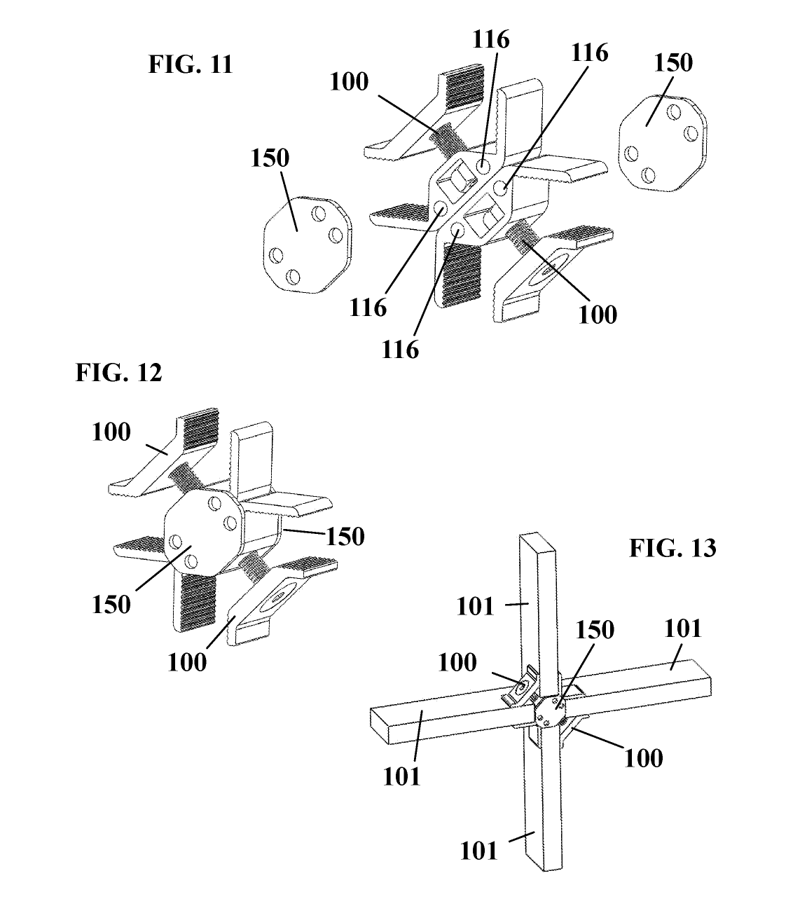

Looking now to FIGS. 8-9 and 11-13 auxiliary hole feature 116 is a geometric feature to enhance the use of panel bracket assembly 100 by functioning as an attachment hole for mounting assembly 100 to a wall or surface, attaching multiple 100 assemblies together, and attaching many common hardware items too the present embodiment such as panel edge trim, rubber feet mounts, and the like. Auxiliary hole features 116 can be tapped with threads and be used to attached mounts for other structural members such as tubes, hanging brackets, hanging hooks, angled connector plates, and the like. Screw 132 (or other fastening elements) passes through hole feature 116 and into wall material 131 to achieve wall mounting of the present embodiment. Linking plate 150 links two 100 panel clamp assemblies through auxiliary holes 116 to form a back-to-back four-way connection. The use of common bolts will secure linking plate 150 to either side of the panel clamp assemblies. Linking plate 150 can be made from a variety of materials to suit structural and aesthetic requirements.

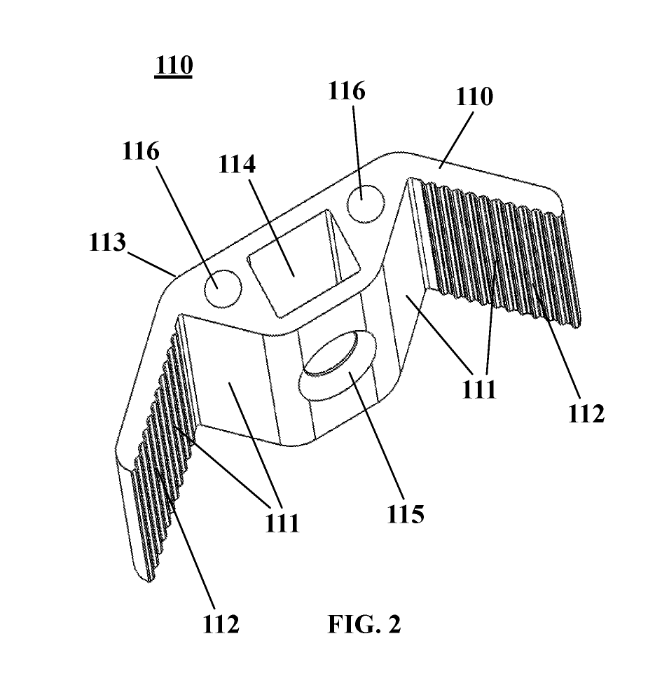

Looking now to FIG. 2 outside surface 113 is the aesthetic side to panel bracket assembly 100 and will be the most visible to a viewer according the present embodiment when configured in a typical furniture or other structural item. It shall be understood that in the present embodiment the outside surface 113 generally has the shape of a beveled angle. This shape can be readily modified to create a variety of aesthetic looks for the panel bracket assembly 100. Outside surface 113 can be a round arc, indented shape, or slotted channel for additional hardware elements.

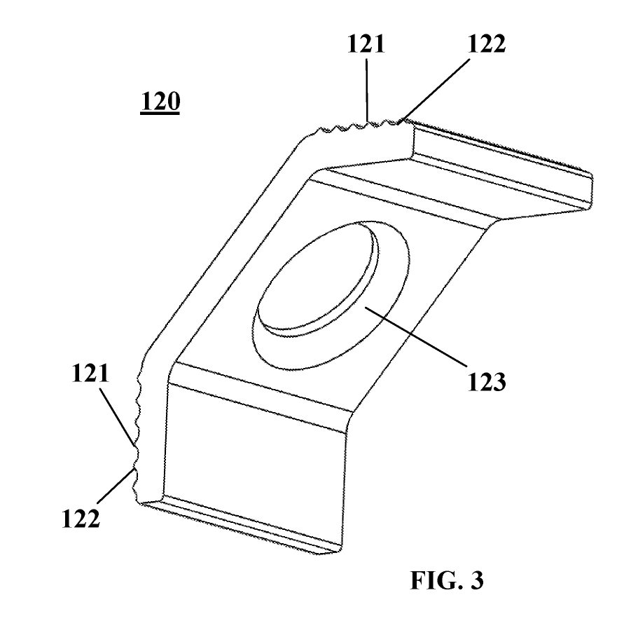

Looking now to FIG. 3 inside structure 120 generally has the shape of a beveled wedge where panel surfaces 121 align with panel material 101 in FIG. 1. It shall be understood that the general shape of inside structure 120 can be modified to engage more or less surface area of panels 101 in FIG. 1 in order to accommodate two different thickness panels in the same panel bracket 100 assembly. In an alternate embodiment, a rounded surface in place of generally flat panel surfaces 121 could rotate to align to panel 101 on either side of screw 103. The present embodiment is designed for generally rectangular panels. It will be understood that the described panel clamp apparatus can also be readily adapted for use to grip round, square, or other shapes of geometric tube. It shall be understood that the panel clamp apparatus can join two or more rectangular panels, or a mix of rectangular and tube shapes, or only tube shapes.

Looking now to FIGS. 14-16, embodiment 300 is shown as being fabricated from sheet metal and comprises sheet metal outside structure 310, sheet metal inside structure 320, screw 303, nut 302 and two panel materials 101. Embodiment 300 accomplishes the same structural function of primary embodiment 100 but has screw 303 entering the assembly from sheet metal outside structure 310. Embodiment 300 illustrates that the design features of embodiment 100 can be manufactured through a variety of processes without departing from the spirit and scope of the invention.

The present invention lends itself to high volume manufacturing in a variety of materials. The primary embodiment can be either extruded in aluminum for clamps of various length or die cast in aluminum for a lowest cost option. FIG. 16 illustrates a sheet metal embodiment of the present invention. Smaller scale embodiments of the present invention for thin panels below ½ inch, or other sized panels not requiring significant structural support, can be readily made from plastics and injection molded. Over molding and die cutting are processes well suited to making rubber or plastic inserts 141 and 142 for the clamp assembly 100.

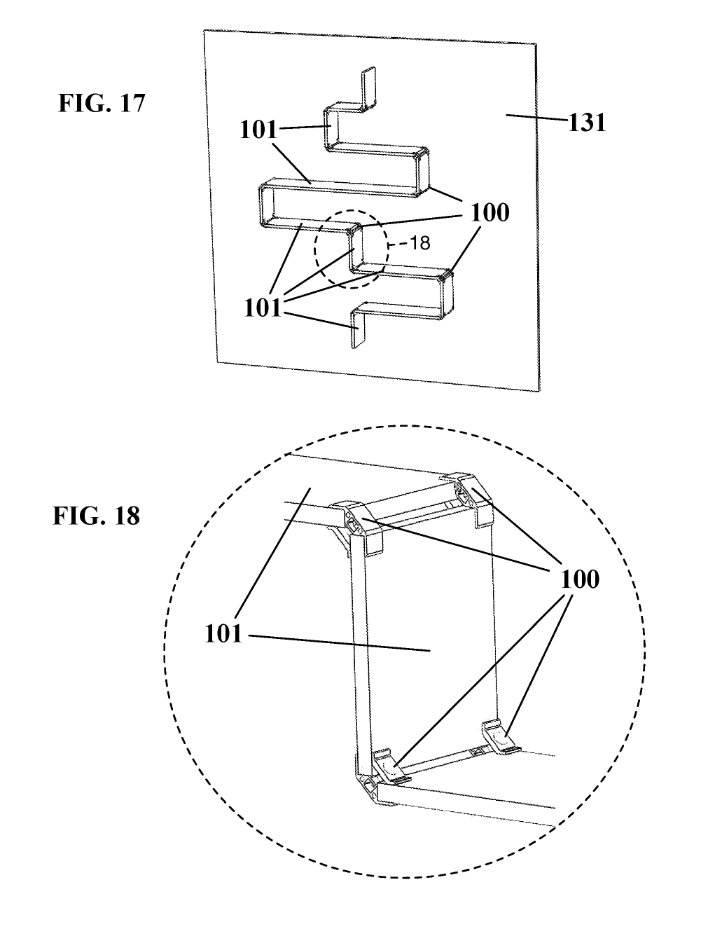

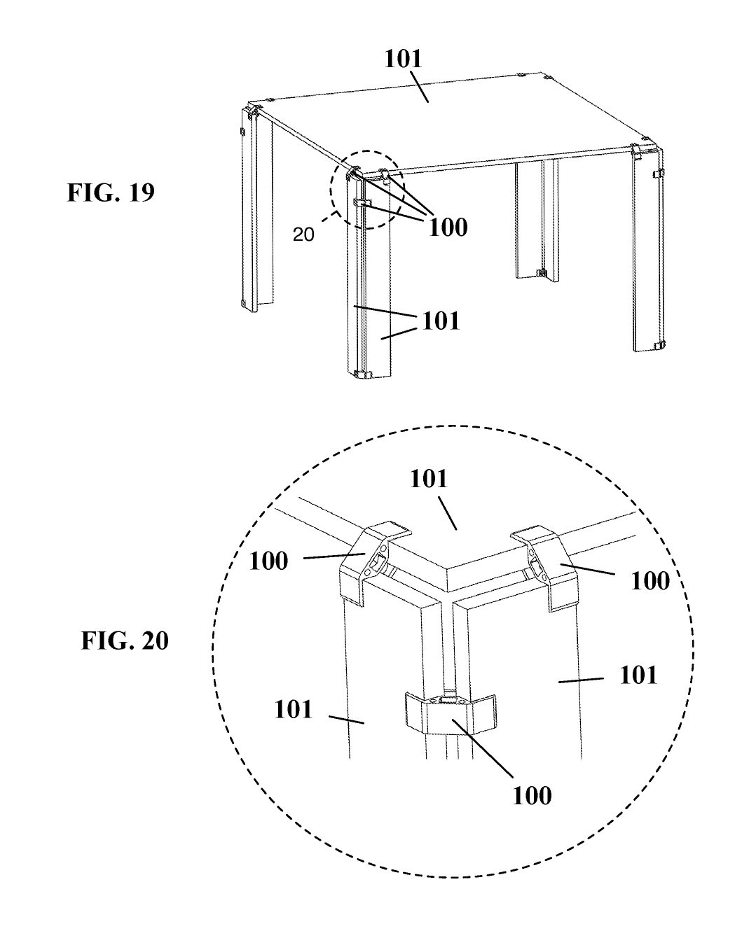

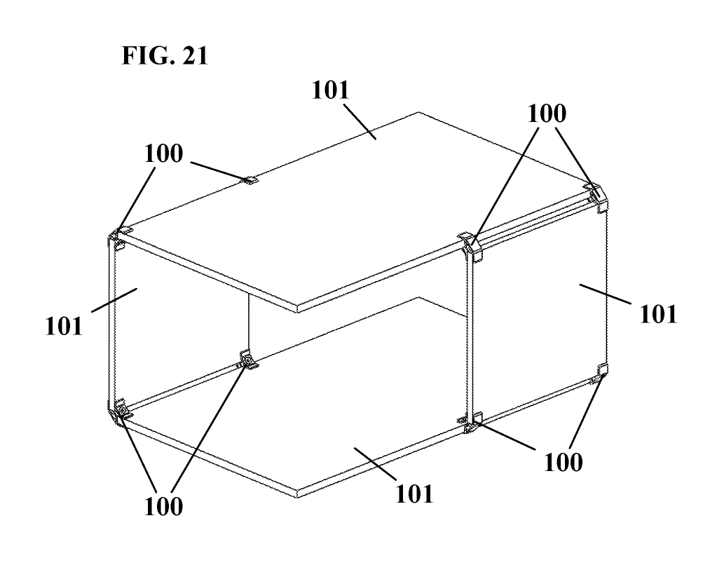

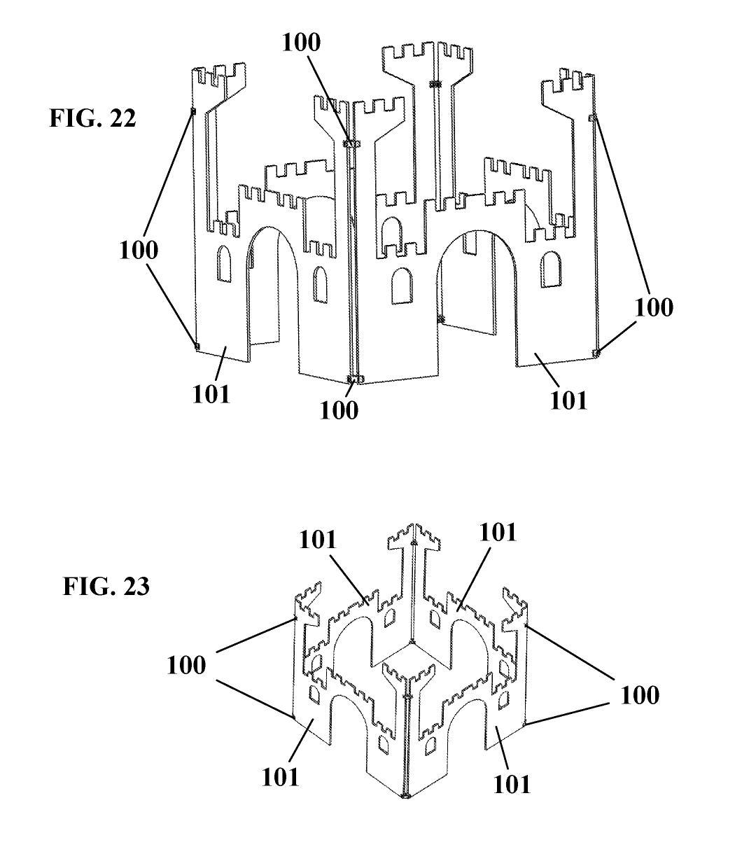

Looking now to FIGS. 17-23 a system of the clamp assemblies 100 can accomplish an almost infinite amount of structural designs. FIGS. 17-18 show an architectural wall shelf fabricated using panels 101, clamp assemblies 100, which are fixably mounted once clamped together to wall material 131 as described earlier. FIGS. 19-20 show a four legged table fabricated using panels 101 of varying sizes and multiple clamp assemblies 100 (16 clamp assemblies are used in the illustrated embodiment shown in FIG. 19). FIG. 21 shows a simple coffee table fabricated using panels 101 of varying sizes and multiple clamp assemblies 100 (8 clamp assemblies are used in the illustrated embodiment shown in FIG. 21). FIGS. 22-23 show a childs playhouse fabricated using panels 101 in the shape of a castle and multiple clamp assemblies 100 (8 clamp assemblies are used in the illustrated embodiment shown in FIG. 22). It will be understood that the use of varying panel shapes and materials further enhances the function, utility, aesthetic appeal, and usability of many different structures that can be fabricated using the current inventive concepts. Optically clear glass; LED lights, solar, speaker and electronic device or electronic device docking panels can further enhance the uniqueness of designs built with the clamp assembly. These structural designs can be used for a wide range of purposes including but not limited to the following: work area solutions, standing desks, seated desks, mobile worktables, mobile carts, monitor stands, work cell dividers, furniture designs, dining tables, coffee tables, end tables, night stands, book shelves, wall shelves, wall boxes, entertainment center, patio furniture, shelving, yard furniture including kids play equipment, benches, climbing walls, dog houses, planter boxes, hanging planter boxes, deck lounge chairs, product displays, angled display stands, stacking display tables, display shelves, dorm furniture, small tables, beer pong tables, slim shelves, and the like. It will be understood that many additional forms and implementations of the panel clamp system of the present invention could be contemplated for a variety of purposes without departing from the scope and spirit of the current invention.

The system and design of the present invention has been described above in terms of functional aspects in schematic diagram format. It is understood that unless otherwise stated to the contrary herein, one or more functions and aspects of the apparatus may be integrated in a single physical device, or one or more functions may be implemented in separate physical devices, without departing from the scope and spirit of the present invention.

It is appreciated that detailed discussion of the actual implementation of each apparatus module is not necessary for an enabling understanding of the invention. The actual implementation is well within the routine skill of a mechanical and system engineer, given the disclosure herein of the system attributes, functionality, and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention.

Accordingly, it is to be understood that the invention is not to be limited by the specific illustrated embodiments.

What is claimed is:

1. A bracket assembly for removably clamping structures to one another, the bracket assembly comprising:
a top member having a top center portion and first and second top end portions on either side of said top center portion, said top center portion including a first transverse channel element having at least two parallel sides for slidably receiving a plurality of different sized nut elements, second and third transverse channels on opposite sides of the first transverse channel for affixing the bracket assembly to a linking element, said first and second top end portions forming an angle with respect to at least one surface of said top center portion; and
a bottom member having a bottom center portion and first and second bottom end portions, said bottom center portion including a hole element for receiving a screw, and said first and second bottom end portions forming an angle with respect to at least one surface of said bottom center portion corresponding to the angle formed by the first and second top end portions, wherein the first and second top end portions and first and second bottom member end portions are operatively coupled to first and second structures in a clamping fashion upon tightening of the screw in one of the nut elements, and release the first and second structures upon loosening of the screw in the nut.

2. The bracket assembly of claim 1, wherein the second and third transverse channels on the top center portion are sized and shaped annularly to allow screw type fastening elements to pass through each of the second and third transverse channels to affix the bracket assembly to a linking element.

3. The bracket assembly of claim 2, wherein at least one of said first and second top end portions and said first and second bottom end portions include a plurality of gripping elements in connection with the linking element for providing additional clamping support to either of the first or second structures upon tightening of the screw in the nut.

4. The bracket assembly of claim 1, wherein the angle formed by both the first and second top end portions and the first and second bottom end portions is a right angle.

5. The bracket assembly of claim 1, wherein the first and second structures comprise material of a uniform thickness which can be operatively clamped between corresponding elements of the first and second top member end portions and the first and second bottom member end portions.

6. The bracket assembly of claim 1, wherein the linking element for providing additional clamping support is comprised of a member sized and arranged to fit the transverse channels of the bracket assembly for purposes of rigidly supporting the bracket assembly structure.
